(19) United States
(12) Patent Application Publication
(10) Pub. No.: US 2023/0027012 A1
(43) Pub. Date: Jan. 26, 2023

(54) APPARATUS FOR CONTROLLING HVAC SYSTEM FOR VEHICLE, AND METHOD THEREOF

(71) Applicants: Hyundai Motor Company, Seoul (KR); Kia Corporation, Seoul (KR)

(72) Inventors: Jung Mo Kwak, Gunpo (KR); Dong Hwan Kim, Daejeon (KR)

(21) Appl. No.: 17/668,157

(22) Filed: Feb. 9, 2022

(30) Foreign Application Priority Data
Jul. 23, 2021 (KR) 10-2021-0097307

(51) Int. Cl. B60H 1/00; B60K 35/00; G06F 3/04817; G06F 3/0488; G06F 21/32

(52) U.S. Cl. CPC B60H 1/00985; B60H 1/00871; B60K 35/00; G06F 3/04817; G06F 3/0488; G06F 21/32; B60K 2370/1468; B60K 2370/119

(57) ABSTRACT

An apparatus for controlling a heating, ventilating and air conditioning (HVAC) system for a vehicle includes a touch screen displaying an interface of the HVAC system for a vehicle, and a controller recognizing a touch of a user and controlling the interface of the HVAC system, displayed on the touch screen, based on the recognized touch.

### CROSS-REFERENCE TO RELATED APPLICATION

This application claims under 35 U.S.C. § 119(a) the benefit of Korean Patent Application No. 10-2021-0097307, filed in the Korean Intellectual Property Office on Jul. 23, 2021, the entire contents of which are incorporated herein by reference.

### BACKGROUND

### (a) Technical Field

The present disclosure relates to an apparatus for controlling a heating, ventilating and air conditioning (HVAC) system for a vehicle, and a method thereof.

### (b) Description of the Related Art

A heating, ventilating and air conditioning (HVAC) system for a vehicle may include a set of apparatuses that integrates the heating, ventilating and/or cooling functions of the vehicle to control an environment inside the vehicle. A conventional HVAC system may control an air conditioning apparatus of the vehicle based on either a four-way mode or a seven-way mode. The HVAC system may include a plurality of wind direction modes. For example, the four-way mode may include four wind direction modes, and the seven-way mode may include seven wind direction modes. However, the conventional HVAC system may only use either the four-way mode or the seven-way mode.

In addition, a driver's safety may be compromised when the mode of the HVAC system for a vehicle may not be switched by a simple operation in a limited space such as within a cabin of a vehicle.

### SUMMARY

An aspect of the present disclosure provides an apparatus capable of switching modes of a heating, ventilating and air conditioning (HVAC) system for a vehicle, and a method thereof.

Another aspect of the present disclosure provides an apparatus capable of switching modes of an HVAC system for a vehicle by a simple operation such as a touch of a user, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a heating, ventilating and air conditioning (HVAC) system for a vehicle includes a touch screen that displays an interface of the HVAC system for a vehicle, and a controller that recognizes a touch of a user and controls the interface of the HVAC system, displayed on the touch screen, based on the recognized touch.

In addition, the controller is operable to display either the first interface or second interface of the HVAC system on the touch screen.

In addition, the first interface may be an interface for a first mode of the HVAC system, and the second interface may be an interface for a second mode of the HVAC system.

In addition, the HVAC system may control an air conditioning apparatus of the vehicle, using wind direction modes of the first mode or wind direction modes of the second mode, the first interface may include a first touch area for switching to the wind direction modes of the first mode, and the second interface may include a second touch area for switching to the wind direction modes of the second mode.

In addition, the controller is operable to switch the first interface displayed on the touch screen to the second interface when the first interface is displayed on the touch screen and a first touch of the user is recognized in the first touch area, and is operable to switch the second interface displayed on the touch screen to the first interface when the second interface is displayed on the touch screen and the first touch of the user is recognized in the second touch area.

In addition, the first touch may be either a touch input for a time longer than or equal to a predetermined first time or two or more touches input at a time interval shorter than or equal to a predetermined second time.

In addition, each of the wind direction modes of the first mode may be selected based on a second touch input to the first touch area, and each of the wind direction modes of the second mode may be selected based on a third touch input to a plurality of icons included in the second touch area.

In addition, the third touch may include one or more touches, and each of the one or more touches included in the third touch may be a touch for each of the plurality of icons.

In addition, the controller is operable to display a text interface for a first mode on the touch screen when the first interface is displayed on the touch screen, and is operable to display a text interface for a second mode on the touch screen when the second interface is displayed on the touch screen.

In addition, the controller is operable to display a graphical interface for the wind direction modes of the first mode on the touch screen when the first interface is displayed on the touch screen, and is operable to display a graphical interface for the wind direction modes of the second mode on the touch screen when the second interface is displayed on the touch screen.

In addition, the controller is operable to display either the first interface or second interface of the HVAC system on the touch screen based on user information received from at least one of a terminal of the user, a facial recognition sensor of the vehicle or a fingerprint recognition sensor of the vehicle.

In addition, the controller is operable to display mode-switching suggestion information, capable of switching a mode to either the first mode or the second mode, on the touch screen, the mode-switching suggestion information being displayed on the touch screen, based on a text interface.

According to another aspect of the present disclosure, a method of controlling an HVAC system for a vehicle includes displaying an interface of the HVAC system for a vehicle; and recognizing a touch of a user, and controlling the interface of the HVAC system, displayed on a touch screen, based on the recognized touch.

In addition, the controlling may include displaying either the first interface or second interface of the HVAC system on the touch screen, the first interface being an interface for a first mode of the HVAC system, and the second interface being an interface for a second mode of the HVAC system.

In addition, the HVAC system may control an air conditioning apparatus of the vehicle based on wind direction modes of the first mode or wind direction modes of the second mode, the first interface may include a first touch area for switching to the wind direction modes of the first mode, and the second interface may include a second touch area for switching to the wind direction modes of the second mode.

In addition, the controlling may further include switching the first interface displayed on the touch screen to the second interface when the first interface is displayed on the touch screen and a first touch of the user is recognized in the first touch area, and switching the second interface displayed on the touch screen to the first interface when the second interface is displayed on the touch screen and the first touch of the user is recognized in the second touch area, the first touch being either a touch input for a time longer than or equal to a predetermined first time or two or more touches input at a time interval shorter than or equal to a predetermined second time.

In addition, each of the wind direction modes of the first mode may be selected based on a second touch input to the first touch area, and each of the wind direction modes of the second mode may be selected based on a third touch input to a plurality of icons included in the second touch area.

In addition, the third touch may include one or more touches, and each of the one or more touches included in the third touch may be a touch for each of the plurality of icons.

In addition, the controlling may further include further displaying a text interface for the first mode on the touch screen when the first interface is displayed on the touch screen, and further displaying a text interface for the second mode on the touch screen when the second interface is displayed on the touch screen.

In addition, the controlling may further include further displaying a graphical interface for the wind direction modes of the first mode on the touch screen when the first interface is displayed on the touch screen, and further displaying a graphical interface for the wind direction modes of the second mode on the touch screen when the second interface is displayed on the touch screen.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an apparatus for controlling a heating, ventilating and air conditioning (HVAC) system for a vehicle according to embodiments;

FIG. 2 shows an example of a first interface and a second interface according to embodiments;

FIG. 3 shows an example of a process in which a controller controls the interface displayed on a touch screen according to embodiments;

FIG. 4 shows examples of a first interface and a second interface according to embodiments;

FIG. 5 shows an example of a process in which a controller controls the interface displayed on a touch screen according to embodiments; and

FIG. 6 shows an example of a method of controlling an HVAC system for a vehicle according to embodiments.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings. In the drawings, the same reference numbers will be used throughout to designate the same or equivalent components. In addition, a detailed description of well-known features or functions will be ruled out in order not to unnecessarily obscure the gist of the present disclosure.

Terms ‘first’, ‘second’, A, B, (a), (b) and the like, may be used in describing components of embodiments of the present disclosure. These terms are used only in order to distinguish any components from other components, and features, sequences or the like of the corresponding components are not limited by these terms. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

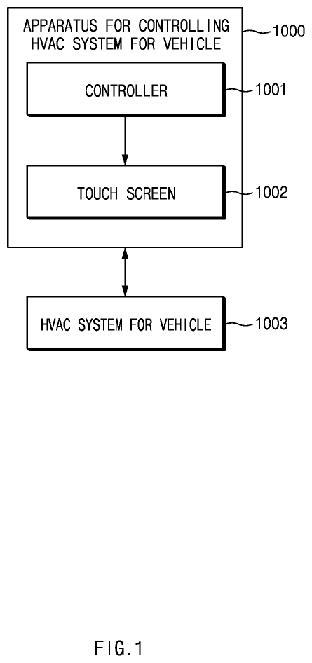

Hereinafter, embodiments of the present disclosure are described in detail with reference to FIGS. 1 to 6.

FIG. 1 shows an example of an apparatus for controlling a heating, ventilating and air conditioning (HVAC) system for a vehicle according to embodiments.

FIG. 1 shows an example of a block diagram showing an apparatus 100 for controlling (a mode of) a heating, ventilating and air conditioning (HVAC) system for a vehicle according to embodiments.

The HVAC system for a vehicle according to embodiments may be a set of apparatuses that integrate the heating, ventilating and/or cooling functions to control an environment inside the vehicle. A conventional HVAC system may control an air conditioning apparatus of the vehicle based on either a four-way mode or a seven-way mode. The HVAC system may include a plurality of wind direction modes of each mode. For example, the four-way mode may include four wind direction modes, and the seven-way mode may include seven wind direction modes. However, the conventional HVAC system may only use either the four-way mode or the seven-way mode.

In addition, safety of the driver may be compromised when a mode of the HVAC system for a vehicle is not capable of being switched to another mode by a simple operation in a limited space, such as a cabin of the vehicle.

The apparatus for controlling the HVAC system for a vehicle according to embodiments may switch the modes (e.g., four-way mode and seven-way mode) of the HVAC system for a vehicle by a simple operation. The apparatus according to embodiments may be positioned outside or inside the vehicle.

The apparatus 1000 for controlling the HVAC system for a vehicle according to embodiments may include a controller 1001 and a touch screen 1002. In addition, the apparatus according to embodiments may control a heating, ventilating and air conditioning (HVAC) system 1003 for a vehicle. A description of the HVAC system for a vehicle is the same as or similar to that described above. The apparatus according to embodiments may further include one or more components not shown in FIG. 1.

The touch screen according to embodiments may display an interface of the HVAC system for a vehicle. For example, the touch screen may be an audio video navigation (AVN) display of the vehicle.

The controller according to embodiments may recognize a touch of a user and control the interface of the HVAC system, displayed on the touch screen, based on the recognized touch. A touch according to embodiments may be input by the user to the above-described touch screen. The interface of the HVAC system according to embodiments may display a user interface for controlling (or selecting) each of the wind direction modes of a specific mode (e.g., four-way mode or seven-way mode) of the above-described HVAC system.

A first mode may be the four-way mode described above, and a second mode may be the seven-way mode described above. The interface of the HVAC system according to embodiments may include a first interface and a second interface. The first interface according to embodiments may be an interface for the first mode. The second interface according to embodiments may be an interface for the second mode. That is, the HVAC system according to embodiments may control the air conditioning apparatus of the vehicle, using the wind direction modes of the first mode or the wind direction modes of the second mode.

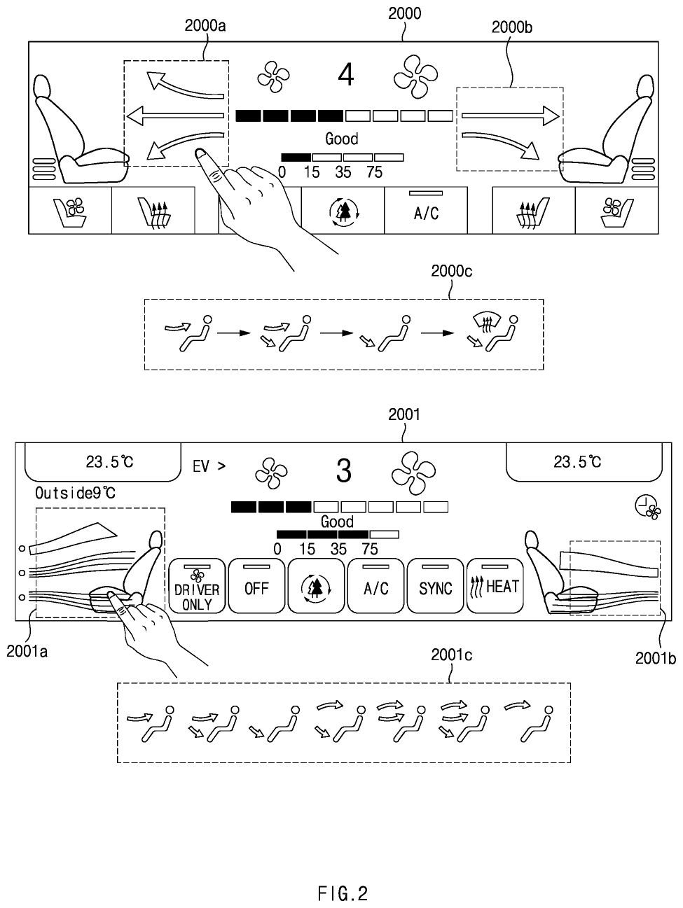

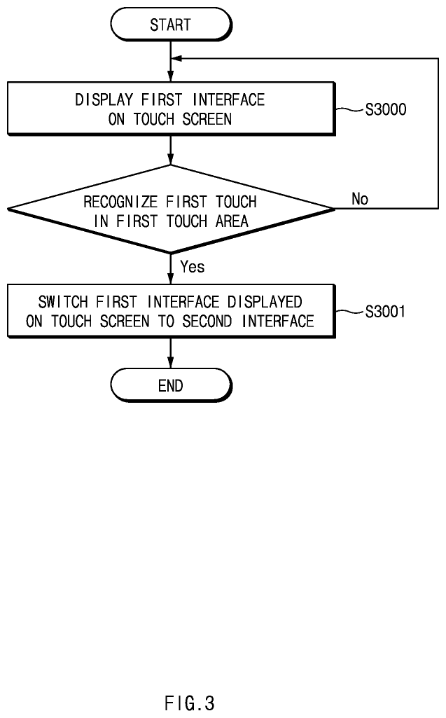

The controller according to embodiments is operable to display either the first interface or second interface of the HVAC system on the touch screen. In addition, according to embodiments, the first interface may include a first touch area for switching to the wind direction modes of the first mode, and the second interface may include a second touch area for switching to the wind direction modes of the second mode. The first touch area and the second touch area according to embodiments may each be a touch area for switching to the modes of the above-described HVAC system. A method is described below with reference to FIGS. 2 and 3, in which the controller according to embodiments allows the modes of the HVAC system to be switched based on the first touch area and the second touch area.

The apparatus according to embodiments may switch the modes (e.g., four-way mode and seven-way mode) of the HVAC system for a vehicle, using the method shown in FIGS. 2 and 3. In addition, the apparatus according to embodiments may switch the modes of the HVAC system for a vehicle by the user's simple operation, using the method shown in FIGS. 2 and 3, thereby providing the user with an efficient operation of the HVAC system and a safe operation of the HVAC system in a driving environment.

FIG. 2 shows examples of the first interface and the second interface according to embodiments.

FIG. 2 shows the examples of the first interface and the second interface (i.e., first interface and second interface described above with reference to FIG. 1) according to embodiments.

Reference number 2000 may indicate an example of the first interface according to embodiments.

As described above with reference to FIG. 1, the first interface may be an interface for the first mode (i.e. four-way mode). In addition, as described above, the four-way mode may be a mode for controlling the air conditioning apparatus of the vehicle based on the four wind direction modes. For example, the four-way mode may control the air conditioning apparatus of the vehicle, using the four wind direction modes as indicated by reference number 2000c.

Reference numbers 2000a and 2000b may each indicate the first touch areas described above with reference to FIG. 1. As described above with reference to FIG. 1, the first interface may include the first touch area for switching to the wind direction modes of the first mode. That is, each of the wind direction modes indicated by reference number 2000c may be selected based on a second touch input to the first touch area. The second touch according to embodiments may be a touch input to the first touch area. The user may thus touch any portion of the second touch area to switch the wind direction modes of the four-way mode.

Each of the wind direction modes of the first mode according to embodiments, indicated by reference number 2000c, may be selected based on the second touch input to the first touch area. For example, the user may touch a specific portion of the first touch area to switch the four wind direction modes indicated by reference number 2000c.

The four-way wind direction mode according to embodiments may include the four wind direction modes as indicated by reference number 2000c. For example, the four wind direction modes included in the four-way wind direction mode may each be determined by combinations of two wind directions. The two wind directions may each be the seated user's middle portion direction and lower portion direction.

That is, the four modes described above may be determined as the middle portion direction, a combination of the middle portion direction and the lower portion direction, the lower portion direction, and a combination of the lower portion direction and a vehicle window direction.

Reference number 2001 may indicate an example of the second interface according to embodiments.

As described above with reference to FIG. 1, the second interface may be the interface for the second mode (i.e. seven-way mode). In addition, as described above, the seven-way mode may be a mode for controlling the air conditioning apparatus of the vehicle based on seven wind direction modes. For example, the seven-way mode may control the air conditioning apparatus of the vehicle, using the seven wind direction modes as indicated by reference number 2001c.

Reference numbers 2001a and 2001b may each indicate the second touch areas described above with reference to FIG. 1. As described above with reference to FIG. 1, the second interface may include the second touch area for switching to the wind direction modes of the second mode. That is, each of the wind direction modes indicated by reference number 2001c may be selected based on a third touch input to a plurality of icons included in the second touch area.

The seven-way wind direction mode according to embodiments may include the seven wind direction modes as indicated by reference number 2001c. For example, the seven wind direction modes included in the seven-way wind direction mode may be determined by combinations of three wind directions. The three wind directions may each be the seated user's middle portion direction, lower portion direction and upper portion direction.

That is, the seven wind direction modes described above may be determined as the middle portion direction, a combination of the middle portion direction and the lower portion direction, the lower portion direction, a combination of the upper portion direction and the lower portion direction, a combination of the upper portion direction and the middle portion direction, a combination of the upper portion direction, the middle portion direction and the lower portion direction, and the upper portion direction.

Each of the plurality of icons according to embodiments may correspond to an icon indicating the wind direction included in the second touch area. Each of the wind direction modes of the second mode according to embodiments may be selected based on a touch input to each of the plurality of icons. For example, the wind direction mode may be determined based on the wind direction corresponding to the icon selected by the touch.

The third touch according to embodiments may thus include one or more touches. Each of the one or more touches included in the third touch according to embodiments may be a touch for each of the plurality of icons.

That is, the first touch area and the second touch area according to embodiments may be touch areas each for switching to the wind direction modes of the above-described first or second mode or selecting one of these wind direction modes. However, the first touch area and the second touch area according to embodiments may also be a touch area for switching to the first mode or the second mode, as described above with reference to FIG. 1. This switching type is described below in detail with reference to FIG. 3.

FIG. 3 shows an example of a process in which the controller controls the interface displayed on the touch screen according to embodiments.

FIG. 3 is a flowchart showing the example of the process in which the controller according to embodiments controls the interface (e.g., first interface or second interface) displayed on the touch screen.

Descriptions of the first interface and the second interface according to embodiments are the same as or similar to those described above with reference to FIGS. 1 and 2.

As described above with reference to FIGS. 1 and 2, the controller according to embodiments may allow the first interface and/or the second interface, displayed on the touch screen, to be switched based on the first touch area and/or the second touch area.

FIG. 3 depicts the process in which the controller allows the interfaces to be switched in a state where the first interface is displayed on the touch screen according to embodiments.

The controller according to embodiments is operable to display the first interface on the touch screen (S3000).

The controller according to embodiments is operable to switch the first interface displayed on the touch screen to the second interface (S3001) when the first interface is displayed on the touch screen and a first touch of the user is recognized in the first touch area. A description of the first touch area is the same as or similar to that described above with reference to FIG. 2.

That is, the controller according to embodiments is operable to switch the interface displayed on the touch screen to another interface when the user inputs the first touch to the first touch area.

The first touch according to embodiments may be a long touch or a double touch. That is, the first touch according to embodiments may be either a touch input for a time longer than or equal to a predetermined first time (e.g., long touch) or two or more touches (e.g., double touch) input at a time interval shorter than or equal to a predetermined second time.

The first touch according to embodiments may be a touch different from both the second touch and the third touch, described above with reference to FIG. 2. For example, the touches such as the second touch and the third touch may be general touches, whereas the first touch may be the long touch or the double touch.

A process, in which the controller controls the interface to be switched to another interface in a state where the second interface is displayed on the touch screen according to embodiments, may be the same or similar to the method described in FIG. 3.

That is, the controller according to embodiments is operable to switch the second interface displayed on the touch screen to the first interface when the second interface is displayed on the touch screen and the first touch of the user is recognized in the second touch area.

The apparatus according to embodiments may switch the modes (e.g., four-way mode and seven-way mode) of the HVAC system for a vehicle, using the method shown in FIG. 3. In addition, the apparatus according to embodiments may switch the modes of the HVAC system for a vehicle by the user's simple operation, using the method shown in FIG. 3, thereby providing the user with an efficient operation of the HVAC system and a safe operation of the HVAC system in a driving environment.

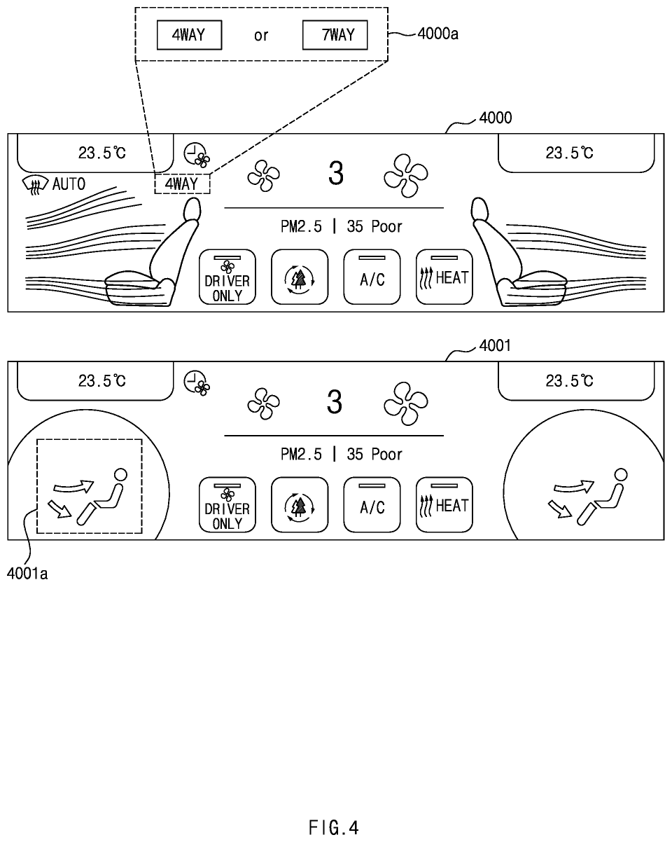

FIG. 4 shows examples of a first interface and a second interface according to embodiments.

FIG. 4 shows the examples of the first interface and the second interface, displayed on the touch screen according to embodiments. Descriptions of the touch screen, the first interface and the second interface according to embodiments are the same as or similar to those described above with reference to FIGS. 1 to 3.

Reference number(s) 4000 and/or 4001 may indicate the example(s) of the first interface and/or the second interface according to embodiments.

As described above with reference to FIGS. 1 to 3, the controller according to embodiments is operable to display the first interface or the second interface on the touch screen. The controller according to embodiments may further be operable to display another interface, by which respective interfaces may be identified from each other, when the first interface or the second interface is displayed on the touch screen.

For example, the controller may further be operable to display a text interface for the first mode on the touch screen when the first interface is displayed on the touch screen. In addition, the controller may further be operable to display a text interface for the second mode on the touch screen when the second interface is displayed on the touch screen. The text interface for the first mode or second mode described above may display “4WAY” or “7WAY,” as indicated by 4000a.

For example, the controller may further be operable to display a graphical interface for the wind direction modes of the first mode on the touch screen when the first interface is displayed on the touch screen. In addition, the controller may further be operable to display a graphical interface for the wind direction modes of the second mode on the touch screen when the second interface is displayed on the touch screen. Reference number 4001a indicates the graphic interface for the wind direction mode of the above-described first mode or second mode.

The apparatus according to embodiments may further display information on the first interface or the second interface, which is displayed on the touch screen, by using the method described in FIG. 4. The vehicle user according to embodiments may efficiently appreciate a mode of the HVAC system for a vehicle, using the information displayed on the touch screen even while driving the vehicle.

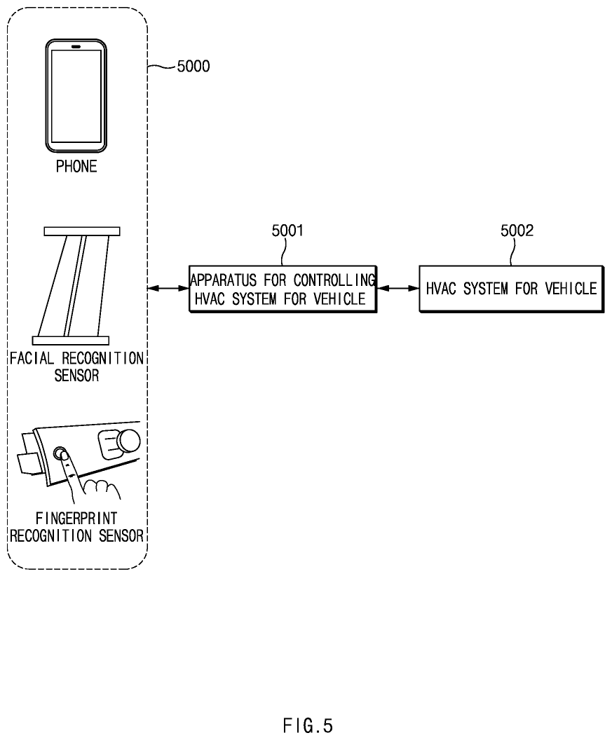

FIG. 5 shows an example of a process in which the controller controls the interface displayed on the touch screen according to embodiments.

FIG. 5 shows the example of the process in which the controller according to embodiments controls the interface displayed on the touch screen. Descriptions of the controller, the touch screen and the interface are the same as or similar to those described above with reference to FIGS. 1 to 4.

The controller according to embodiments may control the interface displayed on the touch screen, using the method described in FIG. 5 as well as the method described above with reference to FIGS. 1 to 4.

Reference number 5000 may indicate each of a terminal of the vehicle user, a facial recognition sensor of the vehicle, and/or a fingerprint recognition sensor of the vehicle. Reference number 5001 may indicate the apparatus for controlling the HVAC system for a vehicle according to embodiments described above with reference to FIGS. 1 to 4. Reference number 5002 may indicate the HVAC system for a vehicle according to embodiments described above with reference to FIGS. 1 to 4.

The controller (described above with reference to FIGS. 1 to 4) included in the apparatus according to embodiments may be operable to display either the first interface or second interface of the HVAC system on the touch screen based on user information received from at least one of the terminal of the user, the facial recognition sensor of the vehicle or the fingerprint recognition sensor of the vehicle.

For example, the controller may receive the information on either the first interface or the second interface from the terminal of the user, and be operable to display the first interface or the second interface on the touch screen. In addition, the controller may receive the information on either the first interface or the second interface from the facial recognition sensor of the vehicle, and be operable to display the first interface or the second interface on the touch screen. In addition, the controller may receive the information on either the first interface or the second interface from the fingerprint recognition sensor of the vehicle, and be operable to display the first interface or the second interface on the touch screen.

The controller according to embodiments may be operable to display mode-switching suggestion information, capable of switching a mode to either the first mode or the second mode, on the touch screen. The mode-switching suggestion information according to embodiments may be displayed on the touch screen, based on a text interface. For example, the mode-switching suggestion information may be displayed in the form of a text interface, “You're usually using 4WAY mode. Would you like to change the mode?”

The mode-switching suggestion information according to embodiments may be generated based on historical data for the first mode or the second mode, selected by the user. A description of a method for the user to select the first mode or the second mode according to embodiments is the same as or similar to that described above. For example, the mode-switching suggestion information may be generated based on the historical data for the mode more selected by the user in a predetermined past period.

The apparatus according to embodiments may switch the modes (e.g., four-way mode and seven-way mode) of the HVAC system for a vehicle, using the method shown in FIGS. 2-4. In addition, the apparatus according to embodiments may switch the modes of the HVAC system for a vehicle by the user's simple operation, using the method shown in FIGS. 2-4, thereby providing the user with an efficient operation of the HVAC system and a safe operation of the HVAC system in a driving environment.

In addition, the apparatus according to embodiments may suggest the user to select either the first mode or the second mode, based on the historical data for the mode of the HVAC system selected by the user.

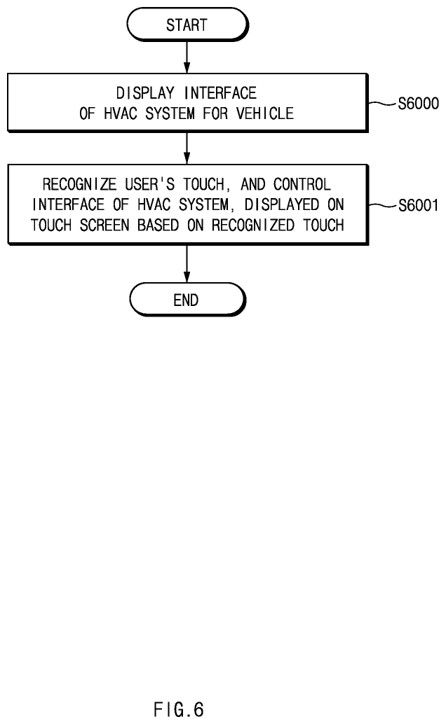

FIG. 6 shows an example of a method of controlling an HVAC system for a vehicle according to embodiments.

FIG. 6 is a flowchart showing the method of controlling (a mode of) the HVAC system for a vehicle according to embodiments.

The method according to embodiments includes displaying an interface of the HVAC system for a vehicle (step S6000); and recognizing a touch of a user, and controlling the interface of the HVAC system, displayed on a touch screen, based on the recognized touch (step S6001). Descriptions of the HVAC system for a vehicle, the interface and the touch screen are the same as or similar to those described above with reference to FIGS. 1 to 5.

Step S6001 according to embodiments may include displaying either a first interface or a second interface of the HVAC system on the touch screen. The first interface according to embodiments may be an interface for the first mode of the HVAC system. The second interface according to embodiments may be an interface for the second mode of the HVAC system. Descriptions of the first interface, the second interface, the first mode and the second mode are the same as or similar to those described above with reference to FIGS. 1 to 5.

The HVAC system according to embodiments may control an air conditioning apparatus of the vehicle based on wind direction modes of the first mode or wind direction modes of the second mode. The first interface according to embodiments may include a first touch area for switching to the wind direction modes of the first mode. The second interface according to embodiments may include a second touch area for switching to the wind direction modes of the second mode. A description of the first touch area is the same as or similar to that described above with reference to FIG. 2.

Step S6001 according to embodiments may further include switching the first interface displayed on the touch screen to the second interface when the first interface is displayed on the touch screen and a first touch of the user is recognized in the first touch area, and switching the second interface displayed on the touch screen to the first interface when the second interface is displayed on the touch screen and the first touch of the user is recognized in the second touch area. A description of the above process is the same as or similar to that described above with reference to FIG. 3.

The first touch according to embodiments may be either a touch input for a time longer than or equal to a predetermined first time or two or more touches input at a time interval shorter than or equal to a predetermined second time. A description of the first touch is the same as or similar to that described above with reference to FIG. 3.

Each of the wind direction modes of the first mode according to embodiments may be selected based on a second touch input to the first touch area Each of the wind direction modes of the second mode according to embodiments may be selected based on a third touch input to a plurality of icons included in the second touch area. Descriptions of the second touch and the third touch are the same as or similar to those described above with reference to FIGS. 1 to 3.

The third touch according to embodiments may include one or more touches. Each of the one or more touches included in the third touch according to embodiments may be a touch for each of the plurality of icons.

Step S6001 according to embodiments may further include further displaying a text interface for the first mode on the touch screen when the first interface is displayed on the touch screen, and further displaying a text interface for the second mode on the touch screen when the second interface is displayed on the touch screen. The text interface for the first mode or second mode is the same as or similar to that described above with reference to FIG. 4.

Step S6001 according to embodiments may further include further displaying a graphical interface for the wind direction modes of the first mode on the touch screen when the first interface is displayed on the touch screen, and further displaying a graphical interface for the wind direction modes of the second mode on the touch screen when the second interface is displayed on the touch screen. The graphical interface for the first mode or second mode is the same as or similar to that described above with reference to FIG. 4.

The apparatus according to embodiments may switch the modes (e.g., four-way mode and seven-way mode) of the HVAC system for a vehicle, using the method shown in FIGS. 2-4 and 6. In addition, the apparatus according to embodiments may switch the modes of the HVAC system for a vehicle by the user's simple operation, using the method shown in FIGS. 2-4 and 6, thereby providing the user with an efficient operation of the HVAC system and a safe operation of the HVAC system in a driving environment.

As set forth above, the present disclosure may switch the modes of the HVAC system for a vehicle.

In addition, the present disclosure may switch the modes of the HVAC system for a vehicle, by a simple operation such as the touch of the user.

In addition, there may be a variety of effects identified directly or indirectly from the present disclosure. The spirit of the present disclosure has been illustratively described hereinabove. It will be appreciated by those skilled in the art that various modifications and alterations may be made without departing from the essential features of the present disclosure.

Accordingly, embodiments disclosed in the present disclosure are provided not to limit the spirit of the present disclosure, but to fully describe the present disclosure, and the scope of the present disclosure is not limited by embodiments. The scope of the present disclosure should be interpreted by the following claims, and all the spirit equivalent to the following claims should be interpreted to fall within the scope of the present disclosure.

What is claimed is:

1. An apparatus for controlling a heating, ventilating and air conditioning (HVAC) system for a vehicle, the apparatus comprising:
a touch screen configured to display an interface of the HVAC system for the vehicle; and
a controller configured to recognize a touch of a user and to control the interface of the HVAC system, displayed on the touch screen, based on the recognized touch.

2. The apparatus of claim 1, wherein the controller is operable to display either a first interface or a second interface of the HVAC system on the touch screen.

3. The apparatus of claim 2, wherein the first interface is an interface for a first mode of the HVAC system, and
the second interface is an interface for a second mode of the HVAC system.

4. The apparatus of claim 3, wherein the HVAC system controls an air conditioning apparatus of the vehicle, using wind direction modes of the first mode or wind direction modes of the second mode,
the first interface includes a first touch area for switching to the wind direction modes of the first mode, and
the second interface includes a second touch area for switching to the wind direction modes of the second mode.

5. The apparatus of claim 4, wherein the controller is operable to switch the first interface displayed on the touch screen to the second interface when the first interface is displayed on the touch screen and a first touch of the user is recognized in the first touch area, and
the controller is operable to switch the second interface displayed on the touch screen to the first interface when the second interface is displayed on the touch screen and the first touch of the user is recognized in the second touch area.

6. The apparatus of claim 5, wherein the first touch is either a touch input for a time longer than or equal to a predetermined first time or two or more touches input at a time interval shorter than or equal to a predetermined second time.

7. The apparatus of claim 4, wherein each of the wind direction modes of the first mode is selected based on a second touch input to the first touch area, and
each of the wind direction modes of the second mode is selected based on a third touch input to a plurality of icons of the second touch area.

8. The apparatus of claim 7, wherein the third touch includes one or more touches, and
each of the one or more touches included in the third touch is a touch for each of the plurality of icons.

9. The apparatus of claim 2, wherein the controller is operable to display a text interface for a first mode on the touch screen when the first interface is displayed on the touch screen, and
the controller is operable to display a text interface for a second mode on the touch screen when the second interface is displayed on the touch screen.

10. The apparatus of claim 4, wherein the controller is operable to display a graphical interface for the wind direction modes of the first mode on the touch screen when the first interface is displayed on the touch screen, and
the controller is operable to display a graphical interface for the wind direction modes of the second mode on the touch screen when the second interface is displayed on the touch screen.

11. The apparatus of claim 2, wherein the controller is operable to display either the first interface or the second interface of the HVAC system on the touch screen, based on user information received from at least one of a terminal of the user, a facial recognition sensor of the vehicle or a fingerprint recognition sensor of the vehicle.

12. The apparatus of claim 3, wherein the controller is operable to display mode-switching suggestion information, capable of switching a mode to either the first mode or the second mode, on the touch screen,
the mode-switching suggestion information being displayed on the touch screen, based on a text interface.

13. A method of controlling an HVAC system for a vehicle, the method comprising:
displaying an interface of the HVAC system for a vehicle; and
recognizing a touch of a user, and controlling the interface of the HVAC system, displayed on a touch, based on the recognized touch.

14. The method of claim 13, wherein the controlling includes displaying either a first interface or a second interface of the HVAC system on the touch screen,
the first interface being an interface for a first mode of the HVAC system, and
the second interface being an interface for a second mode of the HVAC system.

15. The method of claim 14, wherein the HVAC system controls an air conditioning apparatus of the vehicle, using wind direction modes of the first mode or wind direction modes of the second mode,
the first interface includes a first touch area for switching to the wind direction modes of the first mode, and
the second interface includes a second touch area for switching to the wind direction modes of the second mode.

16. The method of claim 15, wherein the controlling further includes:
switching the first interface displayed on the touch screen to the second interface when the first interface is displayed on the touch screen and a first touch of the user is recognized in the first touch area, and
switching the second interface displayed on the touch screen to the first interface when the second interface is displayed on the touch screen and the first touch of the user is recognized in the second touch area,
the first touch being either a touch input for a time longer than or equal to a predetermined first time or two or more touches input at a time interval shorter than or equal to a predetermined second time.

17. The method of claim 15, wherein each of the wind direction modes of the first mode is selected based on a second touch input to the first touch area, and
each of the wind direction modes of the second mode is selected based on a third touch input to a plurality of icons included in the second touch area.

18. The method of claim 17, wherein the third touch includes one or more touches, and
each of the one or more touches included in the third touch is a touch for each of the plurality of icons.

19. The method of claim 14, wherein the controlling further includes:
further displaying a text interface for the first mode on the touch screen when the first interface is displayed on the touch screen, and
further displaying a text interface for the second mode on the touch screen when the second interface is displayed on the touch screen.

20. The method of claim 15, wherein the controlling further includes:
further displaying a graphical interface for the wind direction modes of the first mode on the touch screen when the first interface is displayed on the touch screen, and
further displaying a graphical interface for the wind direction modes of the second mode on the touch screen when the second interface is displayed on the touch screen.
